(19) United States
(12) Patent Application Publication
(10) Pub. No.: US 2017/0277337 A1
(43) Pub. Date: Sep. 28, 2017

(54) Method and Electronic Device for Controlling Terminal

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/332,369

(22) Filed: Oct. 24, 2016

Related U.S. Application Data
(63) Continuation of application No. PCT/CN2016/096286, filed on Aug. 22, 2016.

(30) Foreign Application Priority Data
Mar. 25, 2016 (CN) 2016101805064

(51) Int. Cl. G06F 3/041; G06F 3/0484; G06F 3/044; G06F 3/0482

(52) U.S. Cl. CPC G06F 3/0416; G06F 3/0482; G06F 3/04847; G06F 3/044; G06F 2203/04105

(57) ABSTRACT

Disclosed are a method and electronic device for controlling a terminal. The method for controlling a terminal according to the present disclosure includes: acquiring an operation information of a user in an edge touch area of the terminal; and controlling a cursor in a text selection area on a terminal screen according to the operation information. Therefore, the problem that the text selection mode on the terminal has low selection accuracy and low selection efficiency in the prior art is solved, the accurate control over the cursor in text selection area is achieved, and the selection efficiency is improved.

### CROSS REFERENCE TO RELATED APPLICATIONS

This application is a continuation of International Application No. PCT/CN2016/096286, filed Aug. 22, 2016, and claims priority to Chinese Patent Application No. 2016101805064, filed Mar. 25, 2016, the disclosures of which are hereby incorporated in their entirety by reference.

### TECHNICAL FIELD

The present disclosure relates to the field of communication technology, and more particularly, to a method and electronic device for controlling a terminal.

### BACKGROUND

With the development of science and technology and the improvement of technology, intelligent terminals are increasingly popularized. In order to improve the use efficiency and enhance good user experience, a touch screen is employed in most of the existing intelligent terminals to interact with users.

The way of interaction between a user and a terminal is often done by clicking or sliding function buttons on a screen to realize operation to the terminal. The terminal determines the operation the user is performing by detecting the gesture of the user on the screen.

In the process of implementation of the present disclosure, the inventor found that the prior art at least has the following problems: when a user needs to, e.g., copy, cut, or translate the text displayed on the terminal, the user first selects the text to be processed, and then clicks the buttons, such as copy, cut and translate. This text selection mode on the terminal has the problems of low selection accuracy and low selection efficiency.

### SUMMARY

In view of this, the present disclosure provides a method and electronic device for controlling a terminal to solve the problem that the text selection mode on the terminal has low selection accuracy and low selection efficiency in the prior art.

In order to achieve the above object of the disclosure, on the one hand, the embodiments of the present disclosure provide a method for controlling a terminal, including: acquiring an operation information of a user in an edge touch area of the terminal; controlling a cursor in a text selection area on a screen of the terminal according to the operation information.

According to the abovementioned aspect and any possible implementation way, an implementation way is further provided. The operation information of the user in the edge touch area of the terminal includes: the operation information of the user generated by a sliding operation in the edge touch area of the terminal; or, the operation information of the user generated by a clicking operation in the edge touch area of the terminal; or, the operation information of the user generated by a pressing operation in the edge touch area of the terminal.

According to the abovementioned aspect and any possible implementation way, an implementation way is further provided. The edge touch area of the terminal includes the edge touch area of at least one side surface on the terminal.

According to the abovementioned aspect and any possible implementation way, an implementation way is further provided. The controlling of a cursor in a text selection area on a screen of the terminal according to the operation information includes: controlling a front cursor in the text selection area on the screen of the terminal according to the operation information of the user in the edge touch area on one side surface of the terminal; and/or, controlling a rear cursor in the text selection area on the screen of the terminal according to the operation information of the user in the edge touch area on the other side surface of the terminal.

According to the abovementioned aspect and any possible implementation way, an implementation way is further provided. Before the controlling a cursor in a text selection area on a screen of the terminal according to the operation information, the method further includes: displaying the text selection area on the screen of the terminal according to the operation information of the user on the screen of the terminal.

According to the method for controlling a terminal provided by the embodiments of the present disclosure, the method includes acquiring the operation information of the user in the edge touch area of the terminal, and controlling a cursor in a text selection area on a screen of the terminal according to the acquired operation information. According to the embodiments of the present disclosure, the cursor in the text selection area on the terminal screen is accurately controlled through operation in the edge touch area, thereby solving the problem that the text selection mode on the terminal has low selection accuracy and low selection efficiency in the prior art, achieving accurate control over the cursor in a text selection area, and improving the selection efficiency.

In order to achieve the object of the present disclosure, on the other hand, the embodiments of the present disclosure further provide an electronic device including: at least one processor; and a memory communicably connected with the at least one processor for storing instructions executable by the at least one processor, wherein execution of the instructions by the at least one processor causes the at least one processor to: acquire an operation information of a user in an edge touch area of the terminal; control a cursor in a text selection area on a screen of the terminal according to the operation information.

In order to achieve the object of the present disclosure, on the other hand, the embodiments of the present disclosure further provide a non-transitory computer-readable storage medium storing executable instructions that, when executed by an electronic device, cause the electronic device to: acquire an operation information of a user in an edge touch area of the terminal; control a cursor in a text selection area on a screen of the terminal according to the operation information.

In order to achieve the object of the present disclosure, on the other hand, the embodiments of the present disclosure further provide a computer program product including a computer program stored in the non-transitory computer-readable storage medium, the computer program including program instructions that, when executed by a computer, enable the computer to execute the method provided in any one method mentioned above.

According to the electronic device provided by the embodiments of the present disclosure, the operation information of the user in the edge touch area of the terminal is acquired, and the cursor in the text selection area on the terminal screen is controlled according to the acquired operation information. According to the embodiments of the present disclosure, the cursor in the text selection area on the terminal screen is accurately controlled through operation in the edge touch area, thereby solving the problem that the text selection mode on the terminal has low selection accuracy and low selection efficiency in the prior art, achieving accurate control over the cursor in a text selection area, and improving the selection efficiency.

### BRIEF DESCRIPTION OF THE DRAWINGS

One or more embodiments are illustrated by way of example, and not by limitation, in the figures of the accompanying drawings, where elements having the same reference numeral designations represent like elements. The drawings are not to scale, unless otherwise disclosed.

FIG. 1 is a flow chart of the embodiment 1 of the method for controlling a terminal provided by some embodiments of the present disclosure;

FIG. 2 is a flow chart of the embodiment 2 of the method for controlling a terminal provided by some embodiments of the present disclosure;

FIG. 3 is a schematic diagram of the first structure of the terminal provided by some embodiments of the present disclosure;

FIG. 4 is a schematic diagram of the second structure of the terminal provided by some embodiments of the present disclosure; and

FIG. 5 is a schematic diagram of the hardware structure of the electronic device for executing the method for controlling a terminal provided by some embodiments of the present disclosure.

### DETAILED DESCRIPTION

Hereinafter, the preferred embodiments of the present disclosure are described with reference to the appended drawings, and it will be appreciated that the preferred embodiments described herein are only presented to illustrate and interpreting rather than limiting the present disclosure.

It shall be clear that only a part of the embodiments, instead of all embodiments, of the present disclosure are presented. Based on the embodiments of the present disclosure, all other embodiments concluded by those skilled in the art without making inventive works will fall in the scope of protection of the present disclosure.

As used in the embodiments of the present disclosure, the terms are intended to describe specific embodiments only, and are not intended to limit the present disclosure. The singular forms of “a”, “the” and “this” used in the embodiments and the appended claims of the present disclosure are also intended to include plural forms, unless the extent clearly indicates other meanings.

Depending on the context, as used herein, the word “if” can be interpreted as “at the time of . . . ” or “when . . . ” or “in response to determination” or “in response to detection”. Similarly, depending on the context, the phrase “if it is determined” or “if it is detected (stated conditions or events)” may be interpreted as “when determining” or “in response to determination” or “when detecting (stated conditions or events)” or “in response to detection (stated conditions or events).”

### Embodiment 1

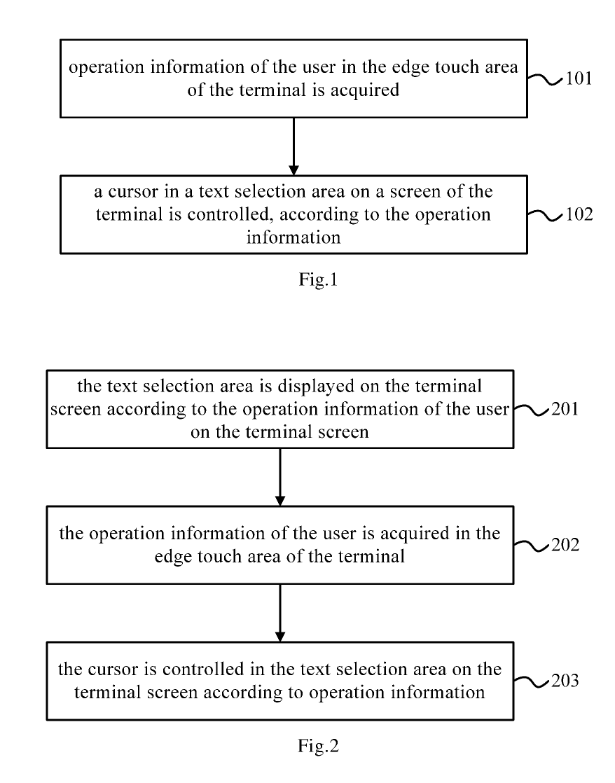

FIG. 1 is a flow chart of the embodiment 1 of the method for controlling a terminal provided by the embodiments of the present disclosure. As shown in FIG. 1, the method for controlling a terminal according to the embodiment may specifically include the following steps 101-102.

101: operation information of the user in the edge touch area of the terminal is acquired.

In the process of using the terminal, especially when the contents need to be copied, cut, or translated, etc. on a text page, a user can press the terminal screen for a long time to turn to the text selection area, and select the text to be copied, cut, or translated. In the prior art, after the text selection area turns out by long pressing the terminal screen, there will be two cursors, one is a front cursor, and the other is a rear cursor. The text between the front cursor and the rear cursor is the selected text. In the embodiment of the disclosure, the positions of the front cursor and/or the rear cursor can be adjusted through the edge touch area of the terminal.

It should be noted that, the terminal involved in the embodiment of the present disclosure may include, but not limited to, a personal computer (PC), a personal digital assistant (PDA), a wireless handheld device, a tablet computer, a mobile phone, a MP3 player, a MP4 player, etc., and the terminal has a screen.

In the embodiment of the present disclosure, the operation information of the user in the edge touch area of a terminal may include, but not be limited to: operation information of the user generated by a sliding operation in the edge touch area of a terminal; or, operation information of the user generated by a clicking operation in the edge touch area of a terminal; or, operation information of the user generated by a pressing operation in the edge touch area of a terminal.

It will be appreciated that, the edge touch control means to provide touch input through a terminal edge, a border or a back and track the light clicking, sliding or pressing operation of a finger on the terminal edge, so as to achieve the terminal control.

The edge touch area of a terminal may be an area on the side surface of the terminal accessible to a user's thumb when the user naturally holds the terminal, and the side surface of the terminal may include other four sides except the front side and back side.

In the embodiment of the present disclosure, the edge touch area of the terminal can be realized using physical buttons, virtual buttons, sensors, or screens, etc.

In the embodiment of the present disclosure, the edge touch area includes the edge touch area of at least one side surface on the terminal.

For example, if a terminal uses a curved surface screen, an edge touch area of the terminal may be implemented using the edge screen of the curved surface screen. Illustrated by a capacitive touch screen, for example, when a user's finger touches the edge touch screen, a contact capacitance will be changed, so that the frequency of an oscillator connected with the capacitor changes, the touch position can be determined by measuring the frequency change of the oscillator, and then the operation information of the user in the edge touch area of the terminal can be acquired.

For another example, if there are physical buttons for volume adjustment on the edge of a terminal, description is provided with the physical button for volume adjustment on the terminal as an example: when a user's finger presses a physical button for volume adjustment, the terminal will know whether the user presses the volume up button or presses the volume down button. Similarly, when a user presses the edge touch area, the terminal can acquire the operation information of the user in the edge touch area of the terminal.

For another example, if there are virtual buttons with certain functions on the edge of a terminal, and the virtual buttons are capacitive virtual buttons, the terminal determines which virtual button is touched by a user through the capacitance of the capacitive virtual button. Specifically, when a user touches a capacitive virtual button, the finger will form a capacitor with an electrode tab in the capacitive virtual button, and the terminal determines the user touch position by detecting the capacitance change, thereby determining which virtual button is touched by the user, and then acquiring the operation information of the user in the edge touch area of the terminal.

For another example, if there are sensors with certain functions on the edge of a terminal, the sensors on the terminal, e.g. a pressure sensor, are taken as an example: when a user presses the pressure sensor, a semiconductor deformation pressure is formed on the surface of the pressure sensor sheet, and a piezoelectric impedance effect is generated by sheet deformation due to pressing, so that the impedance change is converted into an electrical signal. After acquiring the electrical signal, the terminal can determine which pressure sensor or which position on the pressure sensor is pressed by the user, so as to determine which function the pressure sensor pressed by the user has, and then acquire the operation information of the user in the edge touch area of the terminal. In addition, a sensor with certain functions on the edge of a terminal may also be a light sensor.

In the embodiment of the present disclosure, a terminal detects the sliding, clicking or pressing operation of a user by the edge touch area to acquire corresponding operation information.

102: a cursor in a text selection area on a screen of the terminal is controlled, according to the operation information.

After acquiring the operation information of the user in the edge touch area of a terminal, the cursor in the text selection area on the terminal screen can be controlled according to operation information.

Specifically, in the embodiment of the present disclosure, the implementation method for controlling the cursor in the text selection area on the terminal screen may include, but not be limited to: controlling the front cursor in the text selection area on the terminal screen according to the operation information of the user in the edge touch area on one side surface of the terminal; and/or, controlling the rear cursor in the text selection area on the terminal screen according to the operation information of the user in the edge touch area on the other side surface of the terminal.

In the embodiment of the present disclosure, the text selection area appears after long pressing on the terminal screen. A user can control the front cursor and the rear cursor in the text selection area by selecting the edge touch area of different sides.

For example, the front cursor is controlled through the edge touch area of the left side of the terminal, and the rear cursor is controlled through the edge touch area of the right side of a terminal.

For another example, the front cursor is controlled through the left half part in the edge touch area of the upper side of the terminal, and the rear cursor is controlled through the right half part in the edge touch area of the upper side of a terminal.

Specifically, the front cursor movement can be controlled by sliding operation in the edge touch area. For example, if the terminal uses a curved screen, the edge touch area of the terminal can be realized using the edge screen of the curved screen.

Illustrated by a capacitive touch screen, for example, a user performs a sliding operation in the edge touch area of the side surface of the terminal by the index finger, where the sliding operation can be sliding upward, and may also be sliding downward. When the user's finger slides upward, the terminal determines the sliding direction of the user's index finger by detecting the capacitance change, so as to determine that the user's index finger is sliding upward, and control the front cursor on the terminal screen to slide forward by one character according to the upward sliding direction.

Or, the operation of the user in the edge touch area of the terminal may also be a pressing operation.

For example, if there are two physical buttons on the left side of the terminal, when a user's finger presses the two physical buttons, the terminal can acquire the operation information of the user in the edge touch area of the terminal. On the terminal screen, a user controls the front cursor to move forward by one character by pressing an upper physical button of two physical buttons, and controls the front cursor to move backward by one character by pressing a lower physical button of two physical buttons.

Or, the operation of the user in the edge touch area of the terminal may also be a clicking operation.

For example, if there are virtual buttons with certain functions on the edge of the terminal, and the virtual buttons are capacitive virtual buttons, a user performs clicking operation on a virtual button of the terminal by his/her finger, and the terminal determines which virtual button is clicked and how many times the virtual button is clicked by the user according to the capacitance of the capacitive virtual button.

Specifically, when a user clicks a virtual button, the finger will form a capacitor with an electrode tab in the capacitive virtual button, and the terminal determines which virtual button is clicked and how many times the button is clicked by detecting the capacitance change, thereby determining the operation information of the user in the edge touch area of the terminal. In case of one of the virtual buttons is used to control forward movement of the front cursor, and when the virtual button is clicked once, the front cursor is controlled to move forward by one character. The other virtual button thereof is set to control backward movement of the front cursor, and when the virtual button is clicked once, the front cursor is controlled to move backward by one character.

According to the method for controlling a terminal provided by the present disclosure, the operation information of the user in the edge touch area of the terminal is acquired, and the cursor in the text selection area on the terminal screen is controlled according to the acquired operation information. According to the embodiments of the present disclosure, the cursor in the text selection area on the terminal screen is accurately controlled through operation in the edge touch area, thereby solving the problem that the text selection mode on the terminal has low selection accuracy and low selection efficiency in the prior art, achieving accurate control over the cursor in a text selection area, and improving the selection efficiency.

### Embodiment 2

FIG. 2 is a flow chart of the embodiment 2 of the method for controlling terminal provided by some embodiments of the present disclosure. As shown in FIG. 2, the method for controlling a terminal according to the embodiment may specifically include the following steps 201-103.

201: the text selection area is displayed on the terminal screen according to the operation information of the user on the terminal screen.

When a user want to perform operations, such as copy, paste, cut or translation, etc., to a text in a page, in the process of using the terminal, the user selects the words and phrases to be selected by, e.g., long pressing of the screen, and the terminal displays the text selection area on the terminal screen according to the operation information of the user on the terminal screen.

202: the operation information of the user is acquired in the edge touch area of the terminal.

As described in detail in the step 101 of the above embodiment, the principle and realization process of this embodiment of the present disclosure are the same, and are not repeated any more here.

203: the cursor is controlled in the text selection area on the terminal screen according to operation information.

As described in detail in step 102 of the above embodiment, the principle and realization process of this embodiment of the present disclosure are the same, and are not repeated any more here.

According to the method for controlling a terminal provided by the present disclosure, the text selection area is displayed on the terminal screen, then the operation information of the user in the edge touch area of the terminal is acquired, and the cursor in the text selection area on the terminal screen is controlled according to the acquired operation information. According to the embodiment of the present disclosure, the cursor in the text selection area on the terminal screen is accurately controlled through operation in the edge touch area, thereby solving the problem that the text selection mode on the terminal has low selection accuracy and low selection efficiency in the prior art, achieving accurate control over the cursor in a text selection area, and improving the selection efficiency.

### Embodiment 3

This embodiment of the present disclosure further provides an embodiment of the device for realizing each step and the method in the embodiments of the above method. FIG. 3 is a schematic diagram of the first structure the terminal provided by the embodiment of the present disclosure. As shown in FIG. 3, the terminal provided by the embodiment of the present disclosure includes an acquisition module 11 and a control module 12.

The acquisition module 11 is used for acquiring the operation information of the user in the edge touch area of the terminal.

The control module 12 is used for controlling the cursor in the text selection area on the terminal screen according to the operation information acquired by the acquisition module 11.

Where, the operation information of the user in the edge touch area of a terminal includes: operation information of the user generated by a sliding operation in the edge touch area of a terminal; or, operation information of the user generated by a clicking operation in the edge touch area of a terminal; or, operation information of the user generated by a pressing operation in the edge touch area of a terminal.

It should be noted that the edge touch area of a terminal in this embodiment includes the edge touch area on at least one side surface of the terminal.

Where, the control module 12 is specifically used to control the front cursor in the text selection area on a terminal screen according to the operation information of the user in the edge touch area on one side of a terminal; and/or, control the rear cursor in the text selection area on a terminal screen according to the operation information of the user in the edge touch area on the other side surface of the terminal.

The terminal in the embodiment of the present disclosure can be used to execute the technical solution in the embodiment of the method shown in FIG. 1. Its implementation principle and technical effect are similar, and are not repeated any more here.

According to the terminal provided by the present disclosure, the operation information of the user in the edge touch area of the terminal is acquired by the acquisition module 11, and the cursor in the text selection area on the terminal screen is controlled by the control module 12 according to the acquired operation information. According to the embodiment of the present disclosure, the cursor in the text selection area on the terminal screen is accurately controlled through operation in the edge touch area, thereby solving the problem that the text selection mode on the terminal has low selection accuracy and low selection efficiency in the prior art, achieving accurate control over the cursor in text selection area, and improving the selection efficiency.

### Embodiment 4

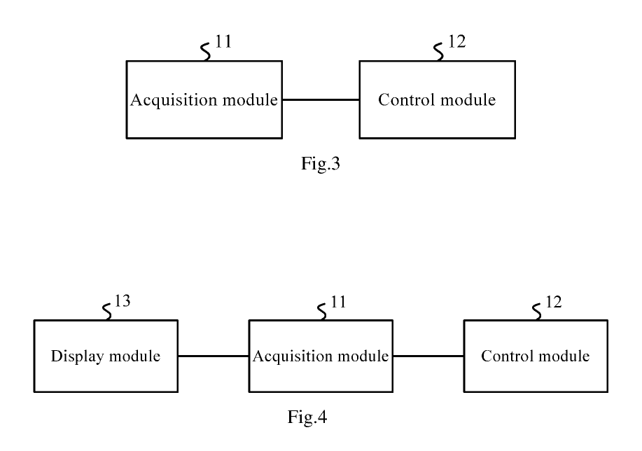

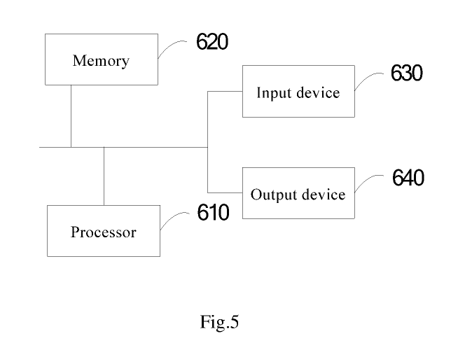

FIG. 4 is a schematic diagram of the second structure of the terminal according to the embodiment of the present disclosure. As shown in FIG. 4, on the basis of the above embodiments, the terminal according to the embodiment of the present disclosure further comprises a display module 13.

The display module 13 displays the text selection area on a terminal screen according to operation information of the user on the terminal screen.

The acquisition module 11 acquires the operation information of the user in the edge touch area of the terminal according to the text selection area shown on the display module 13.

The terminal according to the embodiment of the present disclosure can be used to execute the technical solution in the embodiment of the method shown in FIG. 2. Its implementation principle and technical effect are similar, and are not repeated any more here.

According to the terminal provided by the embodiment of the present disclosure, the text selection area on the terminal screen is displayed by the display module 13, the operation information of the user in the edge touch area of the terminal is acquired by the acquisition module 11, and the cursor in the text selection area on the terminal screen is controlled by the control module 12 according to the acquired operation information. According to the embodiment of the present disclosure, the cursor in the text selection area on the terminal screen is accurately controlled through operation in the edge touch area, thereby solving the problem that the text selection mode on the terminal has low selection accuracy and low selection efficiency in the prior art, achieving accurate control over the cursor in a text selection area, and improving the selection efficiency.

### Embodiment 5

The embodiment of the present disclosure provides a non-volatile computer storage medium storing the computer-executable instructions that can execute the processing method in the embodiments of any one of the above methods.

### Embodiment 6

FIG. 5 is a schematic diagram of the hardware structure of an electronic device executing the method for controlling a terminal provided by the embodiment of the present disclosure. As shown in FIG. 5, the device includes:

one or more processors 610 and a memory 620. One processor 610 is taken as an example in FIG. 5.

The device executing the processing methods of operations of list items may include: an input device 630 and an output device 640.

The processor 610, the memory 620, the input device 630 and the output device 640 can be connected through a bus or by other means. Bus connection is taken as an example in FIG. 5.

As a non-volatile computer-readable storage medium, the memory 620 can be used to store non-volatile software programs, non-volatile computer-executable programs and modules. The processor 610 runs the non-volatile software programs, the instructions and the modules stored in the memory 620, so as to execute various function applications and data processing of an electronic device, that is, implementing the processing method in the embodiments of the above methods.

The memory 620 may include a program storage area and a data storage area, where, the program storage area may store an operating system and applications required by at least one function; the data storage area may store, e.g., data. In addition, the memory 620 may include a high-speed random access memory, and may further include a non-volatile memory, such as at least one disk memory device, a flash memory device, or other non-volatile solid-state memory device. In some embodiments, the memory 620 may optionally include remote memories relative to the processor 610, and these remote memories can be connected to the processing unit over networks. Examples of the above networks include, but are not limited to, Internet, intranets, LANs, mobile communication networks and combinations thereof.

The input device 630 receives input numbers or character information, and generates signal input. The output device 640 may include a display screen and other display devices.

The one or more modules are stored in the memory 620, and execute, when executed by the one or more processors 610: acquiring an operation information of a user in an edge touch area of the terminal; controlling a cursor in a text selection area on a screen of the terminal according to the operation information.

In a possible implementation way, the operation information of the user in the edge touch area of the terminal includes: the operation information of the user generated by a sliding operation in the edge touch area of the terminal; or, the operation information of the user generated by a clicking operation in the edge touch area of the terminal; or, the operation information of the user generated by a pressing operation in the edge touch area of the terminal.

In a possible implementation way, the edge touch area of the terminal comprises the edge touch area of at least one side surface on the terminal.

In a possible implementation way, the controlling of a cursor in a text selection area on a screen of the terminal according to the operation information includes: controlling a front cursor in the text selection area on the screen of the terminal according to the operation information of the user in the edge touch area on one side surface of the terminal; and/or, controlling a rear cursor in the text selection area on the screen of the terminal according to the operation information of the user in the edge touch area on the other side surface of the terminal.

In a possible implementation way, before the controlling a cursor in a text selection area on a screen of the terminal according to the operation information, the method further includes: displaying the text selection area on the screen of the terminal according to the operation information of the user on the screen of the terminal.

The product can execute the method according to the embodiment of the present disclosure, and has corresponding function modules for performing the method and beneficial effects. About the technical details that are not described in detail in this embodiment, please refer to the method according to the embodiment of the present disclosure.

The electronic device according to the embodiment of the present disclosure exists in a variety of forms, including but not limited to:

Mobile communication devices: the characteristic of such devices are that they have mobile communication functions, and mainly aim to provide voice and data communication. Such terminals include: smart phones (such as iPhone), multimedia mobile phones, functional mobile phones, low-end mobile phones, etc.

Ultra-mobile PC devices: Such devices belong to the category of PC, have calculating and processing functions, and usually also have mobile Internet features. Such terminals include: PDA, MID, UMPC devices, etc., such as an iPad.

Portable entertainment devices: Such devices can display and play multimedia contents. Such devices include: audio, video players (such as iPad), handheld game players, e-books, smart toys and portable vehicle navigation devices.

Servers: A device providing computing service. The server components include a processor, hard drives, an internal memory, a system bus, etc. Structure of the service is similar to that of a general computer. But because of the need of providing highly reliable service, so the requirements in respect of the processing capacity, stability, reliability, security, scalability, manageability, etc. are very high.

Other electronic devices having data interaction functions.

The embodiments of the devices described above are presented by way of example are only exemplary, where the units described as separate components may be or may also not be physically separated, and the components shown as a unit may be or may also not be a physical unit, i.e., may be located in one place, or may also be distributed to a plurality of network units. According to the actual need, part or all of the modules thereof are selected to achieve the object of the solution of this embodiment.

Through the description of the above embodiments, those skilled in this art can clearly understand that various embodiments may be realized using software with the addition of a universal hardware platform, and of course, may also be realized by hardware. Based on such understanding, the above technical solution may be essentially reflected or the parts thereof making contribution to related technology may be reflected in the form of software products. The computer software products can be stored in the computer readable storage medium, e.g. ROM/RAM, disk, CD, and the like, including a number of instructions for causing a computer device (a PC, a server, or a network device, etc.) to execute the methods according to various embodiments or some parts of the embodiments.

Finally, it should be noted that: the above embodiments are only presented to show the technical solutions of this application, rather than limiting them. This Application is described in detail with reference to the preceding embodiments, but those skilled in this art shall understand that: they can still modify the technical solutions according to various preceding embodiments, or equivalently replace part of the technical features thereof; and these modifications or replacements do not cause the essence of corresponding technical solutions to depart from the spirit and scope of the technical solutions according to various embodiments of this application.

What is claimed is:

1. A method for controlling a terminal, executed by an electronic device, comprising:
acquiring an operation information of a user in an edge touch area of a terminal;
controlling a cursor in a text selection area on a screen of the terminal according to the operation information.

2. The method according to claim 1, wherein the operation information of the user in the edge touch area of the terminal comprises:
the operation information of the user generated by a sliding operation in the edge touch area of the terminal; or,
the operation information of the user generated by a clicking operation in the edge touch area of the terminal; or,
the operation information of the user generated by a pressing operation in the edge touch area of the terminal.

3. The method according to claim 1, wherein the edge touch area of the terminal comprises an edge touch area of at least one side surface on the terminal.

4. The method according to claim 3, wherein the controlling a cursor in a text selection area on a screen of the terminal according to the operation information comprises:
controlling a front cursor in the text selection area on the screen of the terminal according to the operation information of the user in the edge touch area on one side surface of the terminal; and/or,
controlling a rear cursor in the text selection area on the screen of the terminal according to the operation information of the user in the edge touch area on an other side surface of the terminal.

5. The method according to claim 1, wherein before the controlling a cursor in a text selection area on a screen of the terminal according to the operation information, the method further comprises:
displaying the text selection area on the screen of the terminal according to the operation information of the user on the screen of the terminal.

6. An electronic device, comprising:
at least one processor; and
a memory communicably connected with the at least one processor for storing instructions executable by the at least one processor, wherein execution of the instructions by the at least one processor causes the at least one processor to:
acquire an operation information of a user in an edge touch area of a terminal;
control a cursor in a text selection area on a screen of the terminal according to the operation information.

7. The electronic device according to claim 6, wherein the operation information of the user in the edge touch area of the terminal comprises:
the operation information of the user generated by a sliding operation in the edge touch area of the terminal; or,
the operation information of the user generated by a clicking operation in the edge touch area of the terminal; or,
the operation information of the user generated by a pressing operation in the edge touch area of the terminal.

8. The electronic device according to claim 6, wherein the edge touch area of the terminal comprises an edge touch area of at least one side surface on the terminal.

9. The electronic device according to claim 8, wherein the instructions are executed by the at least one processor causing the at least one processor to:
control a front cursor in the text selection area on the screen of the terminal according to the operation information of the user in the edge touch area on one side surface of the terminal; and/or,
control a rear cursor in the text selection area on the screen of the terminal according to the operation information of the user in the edge touch area on an other side surface of the terminal.

10. The electronic device according to claim 6, wherein the instructions are executed by the at least one processor causing the at least one processor to: display the text selection area on the screen of the terminal according to the operation information of the user on the screen of the terminal.

11. A non-transitory computer-readable storage medium storing executable instructions that, when executed by an electronic device, cause the electronic device to:
acquire an operation information of a user in an edge touch area of a terminal;
control a cursor in a text selection area on a screen of the terminal according to the operation information.

12. The non-transient computer-readable storage medium according to claim 11, wherein the operation information of the user in the edge touch area of the terminal comprises:
the operation information of the user generated by a sliding operation in the edge touch area of the terminal; or,
the operation information of the user generated by a clicking operation in the edge touch area of the terminal; or,
the operation information of the user generated by a pressing operation in the edge touch area of the terminal.

13. The non-transient computer-readable storage medium according to claim 11, wherein the edge touch area of the terminal comprises an edge touch area of at least one side surface on the terminal.

14. The non-transient computer-readable storage medium according to claim 13, wherein when the instructions are executed by an electronic device, causing the electronic device to:
control a front cursor in the text selection area on the screen of the terminal according to the operation information of the user in the edge touch area on one side surface of the terminal; and/or,
control a rear cursor in the text selection area on the screen of the terminal according to the operation information of the user in the edge touch area on an other side surface of the terminal.

15. The non-transient computer-readable storage medium according to claim 11, wherein when the instructions are executed by an electronic device, causing the electronic device to:
display the text selection area on the screen of the terminal according to the operation information of the user on the screen of the terminal.
